(19) United States
(12) Patent Application Publication
(10) Pub. No.: US 2013/0110715 A1
(43) Pub. Date: May 2, 2013

(54) Use of Velocity in Fraud Detection or Prevention

(71) Applicant: Peter Buchhop, Cary, IL (US)

(72) Inventor: Peter Buchhop, Cary, IL (US)

(73) Assignee: BANK OF AMERICA CORPORATION, Charlotte, NC (US)

(21) Appl. No.: 13/283,221

(22) Filed: Oct. 27, 2011

(51) Int. Cl. G06Q 40/02

(52) U.S. Cl. 705/42; 705/44

(57) ABSTRACT

Systems, methods, and software for implementing location-based authentication of financial transactions are provided. Upon receiving credentials to initiate a financial transaction, the geographic location and time of a device associated with the credentials are stored. When a second transaction is attempted, the geographic location and time of the second attempted transaction is determined and, based on a comparison, an implied velocity of travel between the first and second locations is calculated. If the implied velocity exceeds a velocity threshold, the second transaction may be altered or rejected. The threshold may be varied based on several factors.

### BACKGROUND

Most financial institutions, such as banks and credit unions, have increasingly provided on-line and mobile banking and credit services to their customers. Home computers, smartphones, laptops, and other types of devices can now be used to access a bank account or to initiate a credit-card transaction. Unfortunately, the ease with which financial services can be accessed from such devices has given rise to increased opportunities for fraud. For example, if a criminal learns the username and password of an account holder, that criminal may be able to impersonate the user in order to gain access to a bank account or credit card facility.

Beyond typical authentication schemes, such as requiring a user to enter a username and password, financial institutions sometimes employ other schemes to confirm the identity of the person making a transaction. One type of additional verification that may be employed is to compare the geographic location of the computer from which the account is being accessed with a known location of a banking customer (e.g., his or her home address). If a person's home is located in California, for example, but the IP address from the computer attempting to access the account is associated with a foreign country, that discrepancy may signal a possible fraudulent access attempt.

Users of mobile devices (such as smartphones and laptops) may move around frequently, possibly confounding geographic-based verification schemes. A banking customer may log in from a U.S.-based desktop computer one day but, while on vacation in a foreign country, may log in from a different laptop computer or a mobile phone in a different geographic location on a different day. Nevertheless, it is possible to use inferences gleaned from geographically-based information to assist in fraud detection or prevention.

### SUMMARY

Described herein are a system, method, and software product for implementing location-based authentication of an electronic transaction. The transaction may be carried out or attempted, for example, using a bank's online website, or using a mobile banking application that has been installed on a user's mobile device, such as a smartphone. A location-based check may be performed based on a calculated velocity that would be necessary to travel between the geographic locations of two successive attempts to access the financial service and, if the velocity exceeds a threshold, the second transaction may be rejected or otherwise subjected to further scrutiny.

In some variations, when a user attempts to access a financial service from a mobile device, the user's geographic location and time of access is detected and stored. When the same user attempts to access the financial service from a second location at a later time, the approximate distance between the two geographic locations is calculated and compared to a velocity that would be needed to travel between the two geographic locations from which the transactions were initiated. If the velocity exceeds a threshold, the transaction may be canceled or subjected to further authentication schemes.

### BRIEF DESCRIPTION OF THE DRAWINGS

A more complete understanding of the present disclosure and the potential advantages of various aspects described herein may be acquired by referring to the following description in consideration of the accompanying drawings, in which like reference numbers indicate like features, and wherein:

FIG. 1 is a block diagram of an illustrative online transaction system.

FIG. 2 is a flow chart showing illustrative steps that may be performed to carry out various principles of the invention.

FIG. 3 shows a system employing various principles of the invention.

### DETAILED DESCRIPTION

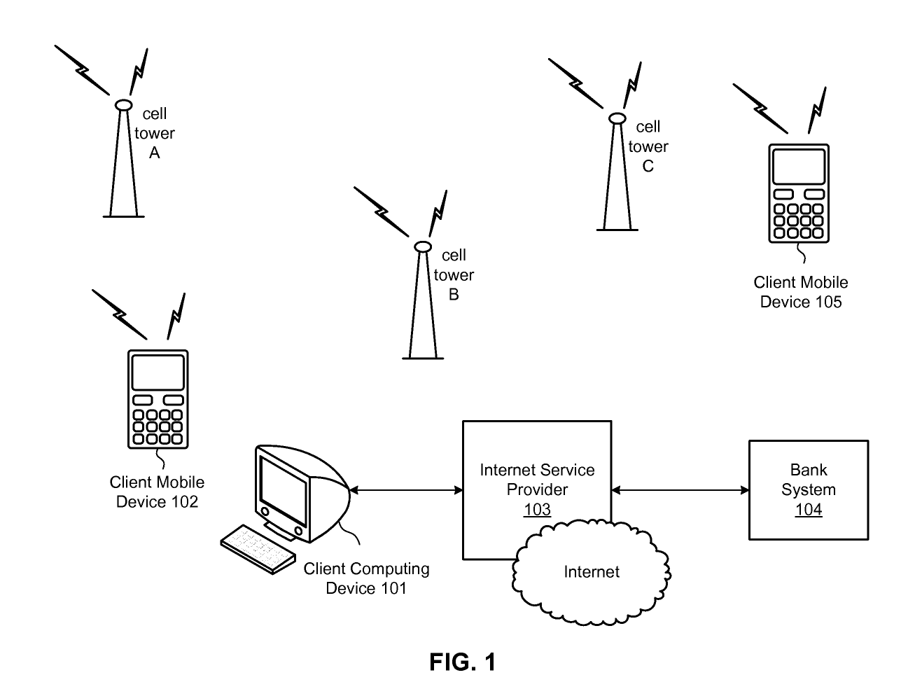

FIG. 1 is a block diagram of an illustrative online financial transaction system which may be used to conduct an online banking transaction or an online credit card transaction. The system in this example includes a client computing device 101, one or more client mobile devices 102 and 105, an Internet service provider 103, a bank system 104, and a cellular telephone network including a plurality of cell towers/base stations A, B, and C.

Although not shown explicitly in FIG. 1, the cell towers may be operated by one or more telecommunications carriers, which may themselves provide Internet access to users of mobile devices through various servers and gateways. Each mobile device, such as a smartphone or laptop computer, may include a web browser that can access the Internet through a Wifi connection and/or the cellular telephone network using a modem.

In this example, client computing device 101 and bank system 104 are communicatively coupled to Internet service provider 103, which in turn provides Internet connectivity to client computing device 101 and bank system 104. Although only one Internet service provider is shown, client computing device 101 and bank system 104 may each be coupled to different Internet service providers. Although communication via the Internet is discussed in the following examples, any other network may be used in addition to the Internet or as an alternative to the Internet. Client computing device 101 may be communicatively coupled to bank system 104 via means other than the Internet. For example, client computing device 101 may communicate with bank system 104 via a satellite link or via a cellular or landline telephone line using one or more modems.

Client mobile devices 102 and 105 may be any portable device having wireless communications capabilities. For example, client mobile devices 102 and 105 may be or include a cellular telephone or pager. Client mobile devices 102 and 105 may further include other features such as a personal digital assistant (PDA) and a computer.

A computing device such as devices 101, 102 and 105 typically includes both hardware (e.g., one or more processors and memories) and software. The software may be stored on a non-transitory computer-readable medium in the form of computer-readable instructions. Such devices may read those computer-readable instructions, and in response perform various steps or functions as defined by those computer-readable instructions. Thus, any functions attributed to a computing device as described herein may be implemented using such computer-readable instructions read and executed by that computing device, and/or by any hardware (e.g., a processor) from which the computing device is composed.

The term “computer-readable medium” as used herein includes not only a single medium or single type of medium, but also a combination of one or more media and/or types of media. Such a computer-readable medium may store computer-readable instructions (e.g., software) and/or computer-readable data (i.e., information that may or may not be executable).

Bank system 104 and Internet service provider 103 may each include one or more computing devices for performing the functions attributed to them as described herein. Further illustrative details regarding bank system 104 will be discussed below.

In operation, client computing devices 101 and mobile devices 102 and 105 may engage in a web browsing session with bank system 104, wherein web pages generated by bank system 104 are displayed on a screen of a customer's computing device. The web page may be, for instance, a web page that allows a user of client computing device 101 to log in to the bank's system (such as using a user ID and a password) and access certain financial accounts for which the user is authorized to gain access. The user may perform certain financial transactions on those accounts, such as making payments from those accounts and transferring funds between accounts. The financial accounts may be banking accounts (e.g., checking accounts, savings accounts, money market accounts, certificate of deposit accounts, investment accounts, loans or lines of credit, etc.) or accounts of other financial institutions.

The financial accounts may also include credit card accounts, such that the user is able to access his or her credit card from another website, which in turn interacts with bank system 104 to process a credit card transaction.

At some point during the Internet web page session, such as during login or during a financial transaction request, bank system 104 may determine whether the login or financial transaction request should be approved or rejected, based on the location of at least one of the devices associated with the user of client computing device 101. For instance, client mobile devices 102 and 105 may both be associated with that user. To do so, bank system 104 may determine the location of both client computing device 101 and of client mobile device 102 and/or 105.

To determine the location of client computing device 101, bank system 104 may determine the IP address of client computing device 101 and cross reference the IP address to a database of one or more IP addresses each mapped to a geographical location. For example, a first IP address may be associated with a first city, while a second different IP address may be associated with a second different city. This process is well known and is commonly referred to as IP geolocation. There are many service providers today that offer IP geolocation services. Thus, bank system 104 may have access to such an IP geolocation service.

Alternatively, bank system 104 may provide its own IP geolocation service, or it may determine or request a geolocation from the cell phone network with which the mobile devices are associated. As an alternative to bank system 104 determining the location of client computing device 101, bank system 104 may receive the self-positioning data from client computing device 101, where client computing device 101 has such a capability.

To determine the location of a client mobile device, such as client mobile device 102, any of various known techniques may be used. For example, a client mobile device may include self-locating capabilities, such as using global positioning system (GPS) and/or dead-reckoning technology. In such a case, the client mobile device may provide information to bank system 104 about its own location. This may be accomplished, for instance, by executing software stored on a computer-readable medium of the client mobile device that causes the client mobile device to send its location to bank system 104 in response to a request from bank system 104. This software may be uploaded to the client mobile device by bank system 104, with the owner's permission.

Another way to determine the location of a client mobile device is to measure the signal strength of a wireless signal emanating from the client mobile device using triangulation or similar methods based on signals detected at multiple cell phone towers.

It is becoming more common for client mobile devices to include a dual wireless communications system. For instance, many cellular telephones now include not only wireless communication capability with standard cell towers, but also wireless communication capability with wireless local area networks (WLANs) such as IEEE 802.11 standard wireless networks. Thus, if the client mobile device is connected to a particular WLAN, and if the location of that WLAN is known, then the location of the client mobile device may also be determined based on which WLAN it is connected to, such as via Internet service provider 103. This is therefore a variation on the above-described IP geolocation technique.

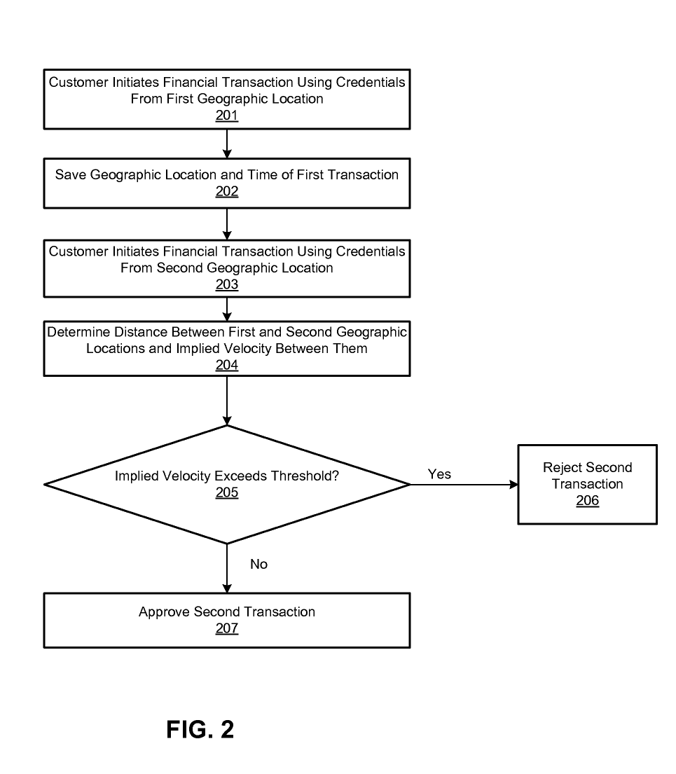

According to some variations of the invention, and as explained in more detail in connection with FIG. 2, the location and time of a customer attempting to make a first financial transaction is determined using one or more of the techniques described above. Assuming the transaction is otherwise approvable, the transaction is consummated. When, however, the same customer attempts to make a second financial transaction, the location and time of the customer are again determined and a comparison is made to the first transaction to determine whether it would be likely that the customer could have traveled between the two locations within the time difference between the two transactions. If not, then the second transaction may be rejected, canceled, or flagged for further scrutiny. For example, if the customer first makes a transaction from a location determined to be Chicago at a certain time, then it would be physically impossible for the same customer to be located in London an hour later.

Instead of outright approval or rejection of the transaction based on a location discrepancy, such a discrepancy may be used as merely one factor in determining a risk score or otherwise taken into account in combination with other factors in deciding whether to approve or reject a transaction.

A computer-readable medium, which may be organized as a relational database, may store data representing a plurality of users (e.g., bank customers) and their associated client mobile devices. For instance, customer A may have client mobile device 102, and customer B may have client mobile device 105. Or, customer A may have both client mobile devices 102 and 105, and customer B may have one or more other client mobile devices not shown in FIG. 1.

FIG. 2 shows a flowchart including various steps that may be carried out according to certain embodiments of the invention. The steps may be performed partly or wholly in computer software and/or hardware. Beginning in step 201, a customer initiates a financial transaction using credentials (e.g., a username and password). As explained above, a determination is made as to what geographic location the transaction was initiated from and, in step 202, the geographic location and the time of the transaction is stored, such as in a database associated with the financial institution to which the transaction is detected. Assuming that the transaction is otherwise approvable, the transaction proceeds normally.

In step 203, a second financial transaction is received purporting to be from the same customer (for example, the same username and password credentials are received). As with step 201, again the geographic location of the transaction is determined and the time is stored.

In step 204, the distance between the two geographic locations, if any, is determined using any of various well-known techniques, such as a look-up table or algorithms that calculate distance between two points. (In some variations, it may be necessary to convert a location from one format to another, such as converting a city name to latitude and longitude coordinates). After determining the distance between the two geographic locations, the implied velocity between the two locations is determined by, for example, dividing the distance by the time between the transactions. For example, if the distance between the two geographic locations is 50 miles, and the transactions were one hour apart, then the implied velocity would be 50 miles per hour. Other approaches for calculating the implied velocity may also be used.

In step 205, a check is made to determine whether the implied velocity exceeds a threshold. In some embodiments, a fixed threshold may be used, such as 500 miles per hour (corresponding to the generally fastest commercial aviation speed). In other embodiments, variable thresholds may be used, such as using a lower threshold when other suspicious behavior is also detected. Different thresholds may also be set for different customers in some embodiments, and for different countries (e.g., lower thresholds when a transaction is received from a foreign country associated with prior fraudulent transactions).

In step 206, if the implied velocity threshold is exceeded, the attempted transaction is rejected (or a previously-started or approved transaction is canceled). Alternatively, the transaction is flagged for further scrutiny using other fraud-prevention techniques. In step 207, if the implied velocity does not exceed the threshold, the transaction is approved or, alternatively, scored higher in combination with other fraud-detection mechanisms.

The granularity of the geographic location may vary depending on different embodiments. In some embodiments, the geographic location may be provided at the granularity of a zip code or city. In other embodiments, more precise latitude and longitude coordinates may be provided. In yet other embodiments, the geographic location may correspond to metropolitan regions, such as counties.

In some variations, a check can be made to determine whether the same device is being used for both transactions, such as by looking up and comparing a device identifier. If different devices are being used for the different transactions, it might be surmised that the customer has not actually moved but perhaps his or her spouse is using the same credentials to initiate the transaction from a different geographic location, and thus the implied velocity check can be overridden in some variations.

In some embodiments, the type of device being used to access the financial system may be determined based on user-supplied or determined information. For example, it may be determined based on information obtained from a web browser used to access a banking web page whether the device is a mobile or non-mobile device, and the capabilities of that device may be detected (e.g., a certain version of web browser is being used). This information may be used in conjunction with the velocity information to assist in fraud detection or prevention. For example, if it is determined that the same mobile device is used for two successive transactions, a higher implied velocity threshold may be permitted, whereas if it is determined that the same desktop computer system is used for two successive transactions, a lower implied velocity threshold may be employed.

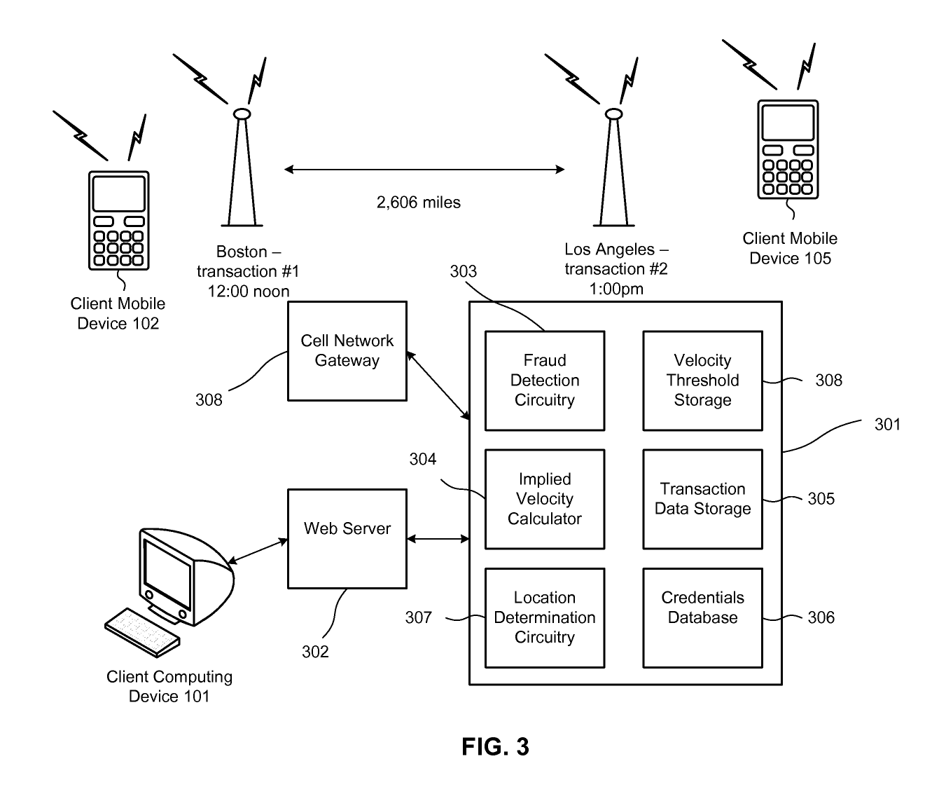

FIG. 3 shows an exemplary configuration of a financial system including functions or circuits (illustrated in boxes) arranged to perform one or more steps as explained above. In this example, the system 301 includes fraud detection circuitry 303 that monitors financial transactions to detect or prevent fraudulent transactions. Also included is a credentials database 306 arranged to store and permit checking of user credentials, and a transaction data storage function 305 arranged to store incoming transactions including their time and determined geographic location in order to permit fraud detection circuitry 303 to approve or reject transactions.

Location determination circuitry 307 may determine the geographic location of an incoming transaction using any of the methods described previously. In some embodiments, circuitry 307 may determine a geographic location by supplying an Internet Protocol (IP) address to an outside vendor or other database that maps static IP addresses to known locations. Circuitry 307 may determine a geographic location for mobile IP addresses by transmitting an incoming IP address as a query to a telecommunications carrier, which then replies with a geographic area indicator for a mobile device that is communicating through that telecommunications carrier's geographic areas.

Implied velocity calculator 304 may calculate an implied velocity between two transactions from the same purported user or device by dividing the determined distance between the geographic locations and the time between successive transaction attempts.

In some embodiments, velocity threshold storage area 308 may store different velocity thresholds for different users or based on other criteria. For example, when one of the geographic locations is located outside of the United States, a lower threshold may be used in some embodiments (e.g., 250 miles per hour), whereas a higher threshold (e.g., 500 miles per hour) may be used when successive transactions both originate from within the United States. Fraud detection circuitry 303 operates in conjunction with the other functions and storage areas to carry out steps such as those illustrated in FIG. 2.

A web server 302 may provide web-based access to client computing devices such as device 101, whereas one or more cell network gateways 308 may provide web-enabled connectivity to one or more mobile devices such as cell phones or laptop computers.

As illustrated in FIG. 3, a first transaction from client mobile device 102 corresponding to a particular banking customer is processed at 12 noon, and is determined to originate from Boston, Mass. One hour later, a second transaction presenting the same credentials is received from Los Angeles, Calif., more than two thousand miles away, from the same or a different mobile device 105. Fraud detection circuitry 303 may determine that the implied velocity in such a situation is more than two thousand miles per hour, far above a numerical velocity threshold of (e.g.) 500 miles per hour. Accordingly, such a transaction can be rejected or flagged for extra scrutiny using other fraud-prevention techniques.

The functions in system 301 may be implemented by hardware and/or by software stored in computer-readable media and executed by various computing devices, such as a server computer including one or more processors programmed with software.

The divisions between functional blocks in FIG. 3 are merely illustrative, and that the physical division of computing devices and other equipment may be different from the functional division. Moreover, some or all of the functional blocks may be combined or further subdivided functionally and/or physically.

Thus, various systems, methods, and software have been described for implementing location-based authentication of both online and mobile web-based transactions. While the various examples discussed herein have been directed to a bank providing a banking website and the customer performing financial transactions, the aspects described herein may be used with any type of transactions implemented electronically, such as on any type of website.

1. A method, comprising:
receiving from a first electronic device first credentials regarding a first financial transaction;
determining a first geographic location associated with the first electronic device and a first time at which the first credentials were received;
receiving from a second electronic device the first credentials regarding a second financial transaction;
determining a second geographic location associated with the second electronic device and a second time at which the first credentials were again received;
calculating, at an implied velocity calculator, an implied velocity of travel between the first geographic location and the second geographic location based on a distance between the first and second geographic locations and a time difference between when the first credentials were successively received; and
altering an approval mechanism for the second financial transaction if a velocity threshold is exceeded.

2. The method of claim 1, wherein altering the approval mechanism comprises rejecting the second financial transaction if the velocity threshold is exceeded.

3. The method of claim 1, wherein altering the approval mechanism comprises adjusting a risk score associated with the second financial transaction.

4. The method of claim 1, wherein the first and second electronic devices are determined to be the same device.

5. The method of claim 1, wherein the first and second financial transactions relate to an online banking transaction.

6. The method of claim 1, wherein the velocity threshold varies depending on a particular user.

7. The method of claim 1, wherein the velocity threshold varies depending on the first or second geographic location.

8. The method of claim 1, wherein the first credentials comprise a username and password.

9. The method of claim 1, wherein one of the first and second geographic locations is determined by transmitting an IP address to a telecommunications carrier and receiving in response thereto a geographic location corresponding to a mobile user.

10. One or more non-transitory computer-readable media having instructions stored thereon that, when executed by a processor, cause an apparatus to:
receive from a first electronic device first credentials regarding a first financial transaction;
determine a first geographic location associated with the first electronic device and a first time at which the first credentials were received;
receive from a second electronic device the first credentials regarding a second financial transaction;
determine a second geographic location associated with the second electronic device and a second time at which the first credentials were again received;
calculate an implied velocity of travel between the first geographic location and the second geographic location based on a distance between the first and second geographic locations and a time difference between when the first credentials were successively received; and
alter an approval mechanism for the second financial transaction if a velocity threshold is exceeded.

11. The one or more computer-readable media of claim 10, wherein altering the approval mechanism comprises rejecting the second financial transaction if the velocity threshold is exceeded.

12. The one or more computer-readable media of claim 10, wherein altering the approval mechanism comprises adjusting a risk score associated with the second financial transaction.

13. The one or more computer-readable media of claim 10, wherein the first and second electronic devices are determined to be the same device.

14. The one or more computer-readable media of claim 10, wherein the first and second financial transactions relate to an online banking transaction.

15. The one or more computer-readable media of claim 10, wherein the velocity threshold varies depending on a particular user.

16. The one or more computer-readable media of claim 10, wherein the velocity threshold varies depending on the first or second geographic location.

17. The one or more computer-readable media of claim 10, wherein the first credentials comprise a username and password.

18. The one or more computer-readable media of claim 10, wherein one of the first and second geographic locations is determined by transmitting an IP address to a telecommunications carrier and receiving in response thereto a geographic location corresponding to a mobile user.

19. An apparatus comprising:
a processor; and
a memory storing instructions that, when executed, cause the apparatus to:
receive from a first electronic device first credentials regarding a first financial transaction;
determine a first geographic location associated with the first electronic device and a first time at which the first credentials were received;
receive from a second electronic device the first credentials regarding a second financial transaction;
determine a second geographic location associated with the second electronic device and a second time at which the first credentials were again received;
calculate an implied velocity of travel between the first geographic location and the second geographic location based on a distance between the first and second geographic locations and a time difference between when the first credentials were successively received; and
alter an approval mechanism for the second financial transaction if a velocity threshold is exceeded.

20. The apparatus of claim 19, wherein altering the approval mechanism comprises rejecting the second financial transaction if the velocity threshold is exceeded.

21. The apparatus of claim 19, wherein altering the approval mechanism comprises adjusting a risk score associated with the second financial transaction.

22. The apparatus of claim 19, wherein the first and second electronic devices are determined to be the same device.

23. The apparatus of claim 19, wherein the first and second financial transactions relate to an online banking transaction.

24. The apparatus of claim 19, wherein the velocity threshold varies depending on a particular user.

25. The apparatus of claim 19, wherein the velocity threshold varies depending on the first or second geographic location.

26. The apparatus of claim 19, wherein the first credentials comprise a username and password.

27. The apparatus of claim 19, wherein one of the first and second geographic locations is determined by transmitting an IP address to a telecommunications carrier and receiving in response thereto a geographic location corresponding to a mobile user.
